(19) United States
(12) Patent Application Publication
(10) Pub. No.: US 2010/0225960 A1
(43) Pub. Date: Sep. 9, 2010

(54) METHOD AND SYSTEM FOR PRINTING AN ADVERTISEMENT WITH A DOCUMENT

(76) Inventors: Harish B KAMATH, Bangalore (IN); Ajay Gupta, Bangalore (IN); Krishnan Ramanathan, Bangalore (IN); Nidhi Mathur, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/425,389

(22) Filed: Apr. 17, 2009

(30) Foreign Application Priority Data
Mar. 5, 2009 (IN) 492/CHE/2009

(51) Int. Cl. G06F 3/12; G06F 17/00; G06Q 30/00

(52) U.S. Cl. 358/1.15; 715/274; 705/14.53

(57) ABSTRACT

Presented is a method and system for printing an advertisement with a document. The method includes receiving a print request for a document from a user, converting the requested document into a vector graphics format document, selecting at least one advertisement for inclusion into the vector graphics format document, recording the vector graphics format document into a print driver queue enabled to print advertisements, inserting at least one advertisement into the vector graphics format document and printing the advertisement with the vector graphics format document.

### RELATED APPLICATIONS

Benefit is claimed under 35 U.S.C. 119(a)-(d) to Foreign application Serial No. 492/CHE/2009 entitled “METHOD AND SYSTEM FOR PRINTING AN ADVERTISEMENT WITH A DOCUMENT” by Hewlett-Packard Development Company, L.P., filed on 5 Mar. 2009, which is herein incorporated in its entirety by reference for all purposes.

### BACKGROUND

It has been a constant endeavor and desire of advertisers to reach maximum number of people with minimum amount of cost. Various methods have been tried to achieve this goal. One of the most successful of these methods is to use the internet. It is an undisputed fact that no medium has a presence as vast and large than the World Wide Web. The growth in the number of electronics devices over the years has put this simple yet powerful medium into the hands of one and all. The advertisers have been quick to realize the potential of internet to their advantage. In fact, it is widely believed that the growth in advertising over the internet has surpassed any other medium such as print.

In their endeavor to reach maximum people, the advertisers have been trying to balance their client's need to reach a select audience. The internet offers a very useful option in this regard. It allows advertisers to provide personalized advertisements to potential customers. However, introducing an advertisement into a document on a platform is possible provided the document format or application contains support. This requires developing a specific module for a particular application and exposes consequent dependency on applications, document formats and a level of pre-processing. It is desirable to formulate a mechanism that overcomes these limitations.

### BRIEF DESCRIPTION OF THE DRAWINGS

For a better understanding of the invention, embodiments will now be described, purely by way of example, with reference to the accompanying drawings, in which:

FIG. 1 shows a flow diagram of a method for printing an advertisement with a document according to an embodiment.

FIG. 2 shows a system for printing an advertisement with a document according to an embodiment.

FIG. 3 shows an example of a computer user interface for printing an advertisement with a document according to an embodiment.

FIG. 4 shows an example of a computer user interface according to an embodiment.

### DETAILED DESCRIPTION OF THE INVENTION

It may be noted that the term “document” herein includes both a single page and a multiple-page document.

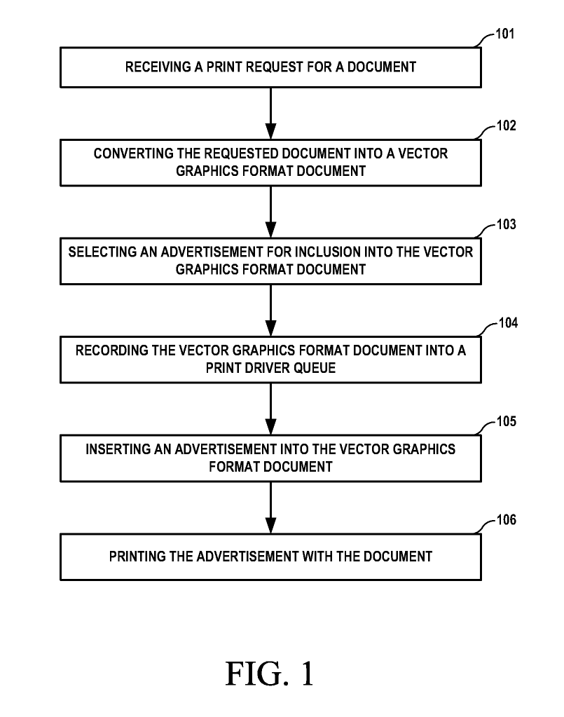

FIG. 1 shows a flow diagram of a method for printing an advertisement with a document according to an embodiment. The method may be performed in a computer system or any electronic device that enables printing of a document.

Step 101 includes receiving a print request for a document from a user. For example, a user may request printing of a spreadsheet document or a word processor document. Further, the document requested may originate from any computer application, such as, but not limited to, MS Word, MS Excel, MS Power Point, MS Outlook, MS Internet Explorer, etc.

Step 102 includes converting the requested document, for which a print request has been received, into a vector graphics format document or an intermediate representation.

A vector graphics format document is an image file format for storing and organizing images. It contains a geometric description of the image data, which is stored in the form of vectors. Windows Metafile (WMF) is a good example of a vector graphics file format. It is the native format for Microsoft Windows system and forms the basis of many Microsoft Office applications such as Word and Power Point. An advanced version of the Windows Metafiles format is the Enhanced Metafile (EMF) format. The EMF is considered an extension of the WMF and has been developed for use with 32 bit Windows applications. It can contain a much broader variety of commands than WMF and an image stored in this format is portable to another application.

The requested document is converted into a vector graphics format document or an intermediate representation independent of document generating application. For example, a document may originate from a MS Word application, a MS Excel application or a MS Power Point application; it gets converted into a vector graphics format document irrespective of the generating application. In an embodiment of the invention, the document, for which a print request has been received, is converted into an EMF format document. A software tool or utility, such as, EMF Printer, may be used for converting a document into an EMF format document.

Step 103 includes selecting an advertisement for inclusion into the vector graphics format document or an intermediate representation. One or more advertisements may be included into the document. The advertisement may be stored in the computer system or received remotely from a server, such as a web server. The storage may be in the form of primary storage (RAM, cache memory, etc.) and/or secondary storage (hard disk, magnetic tape, floppy disk, flash memory etc.). The internet or any other suitable network, such as a LAN, WAN and/or MAN, may be used to connect the computer system with the remote server.

Further, personalized advertisement(s) may be included into the vector graphics format document. In this regard, an advertiser may be allowed to publish (upload) its advertisements to a remote advertisement server and also specify rules against those advertisements. To provide an example, Hewlett-Packard (HP) Company may publish advertisements related to printers, computer systems, scanners, PDAs, servers, etc. and specify rules against them. Rules may vary depending upon an advertiser's needs. For example, a rule may specify that a server advertisement is to be downloaded if a request originates from a corporate user and a computer system advertisement is to be allowed if the request originates from a non-corporate user.

To differentiate between different types of users, a personalization module is provided on a user's computer system in order to generate the user's profile. The personalization model captures a user's demographic and behavioral profile, and stores these details in a profile database. The module may also capture the context of a user (current location, current browsing session, etc.). To provide an example, the personalization model may capture a user's internet browsing behavior, such as details of web sites visited, the frequency of visit, the time spent at a web site, and record these details in the profile database. In another example, the personalization model may capture the demographic details of a user, such as, but not limited to, age of the user, income details, sex, education, etc. The user details are regularly updated and stored in the profile database.

An advertisement downloader and matcher (ADM) module is employed on a user's computer system to interact with the personalization module and the advertisement server. The ADM is configured to download advertisements that match the rules specified by an advertiser on an advertisement server. It interacts with the personalization module to obtain a user's demographic, behavioral and contextual details, and uses these details to download corresponding matching advertisements. The downloaded advertisements are stored in an advertisement database on the user's computer system for later use and the selection statistics related to downloaded advertisements (such as, number of times an advertisement has been downloaded, types of advertisements that have been downloaded, etc.) are uploaded to the online server, which maintains a record of all downloads. Future advertisements may be selected based on past advertisement preferences of the user. To provide an example, if a user regularly browses web sites related to printer devices, the user's browsing details (such as, model number of the printers searched, printer manufacturer details, dealer location information etc.) are captured by the personalization module, and based on captured details, the ADM downloads advertisements that correspond to user's browsing history. In this regard, the ADM also takes into account the rules specified by an advertiser on the advertisement server. In the present example, an advertiser may specify a rule that an advertisement related to Hewlett-Packard (HP) Company printers is to be downloaded if the user has searched for HP's printers while browsing. Another rule may further specify downloading of laser printer advertisements if the same has figured in the user's search. Any number of rules may be specified by an advertiser against the uploaded advertisements, as the advertisements aim to provide content directed to a user's needs.

In an exemplary embodiment, upon receiving a print request for a document from a user, the advertisement downloader and matcher module selects a personalized advertisement(s) from the advertisement database for inclusion into an EMF format document.

In another embodiment, the advertisement(s) is selected from the cached memory of the computer system and the selection details are uploaded to the advertisement server whenever the computer system becomes online again.

In a still another embodiment, the user may manually select an advertisement(s) for inclusion. In this regard, a thumbnail version of the advertisements may be provided on the user's computer system to aid in user's selection.

Step 104 includes recording the vector graphics format document or the intermediate representation into a print driver queue enabled to print advertisements. In an embodiment, a special purpose distinct print driver, “Ad-Sponsored print driver”, is provided in the print sub-system of the user's computer system and the vector graphics format document is recoded into the Ad-Sponsored print driver queue. Since a user may choose to print more than one document at a time, a series of multiple documents may get converted into vector graphics format documents in step 102. A print spooler is used to record the converted vector graphics format documents into a print driver queue, creating spool files. In an exemplary embodiment, EMF format documents are recorded into the print driver queue.

In step 105, a print processor is deployed to be part of the print driver queue formed in step 104. The print processor processes the print driver queue and inserts at least one advertisement, selected in step 103, into each of the vector graphics format documents or intermediate representations. In an exemplary embodiment, at least one advertisement is inserted into an EMF format document.

In step 106, the vector graphics format documents (or intermediate representations) along with the inserted advertisement(s) are sent to a printer system for printing. A print-preview of a graphics format document along with the inserted advertisement may be viewed on the user's computer system prior to printing in step 106. In an exemplary document, an EMF format document along with the inserted advertisement is sent to a printer system for printing.

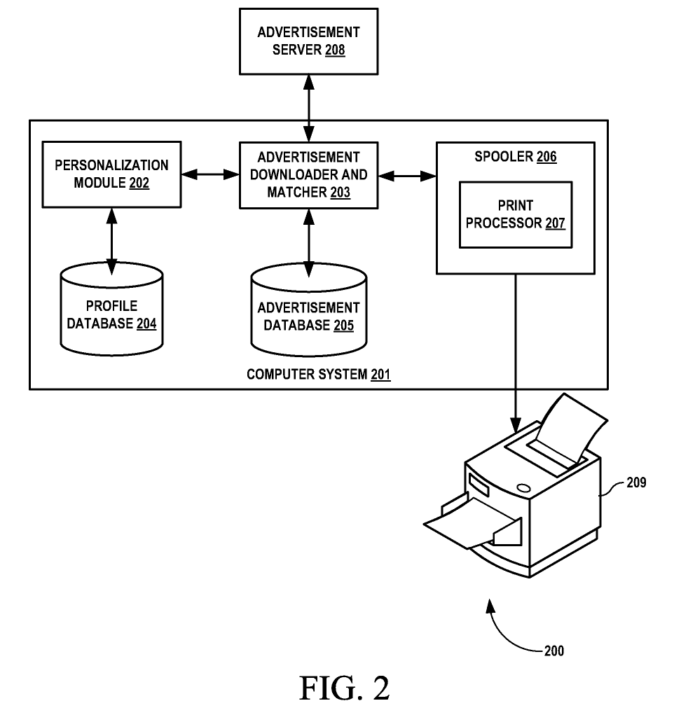

FIG. 2 shows a system (200) for printing an advertisement with a document according to an embodiment. The system (200) comprises a conventional computer system (201), an advertisement server (208) and a printer system (209). The conventional computer system (201) is configured to include a personalization module (202), a profile database (204), an advertisement downloader and matcher module (203), and an advertisement database (205). It further includes a print spooler (206) and a print processor (207). The computer system (201), the advertisement server (208) and the printer system (209) are connected through the internet or another suitable network, such as, a LAN, a WAN and/or a MAN.

The personalization module (202) of the computer system (201) is responsible for capturing demographic and behavioral profile of the user. The demographic profile is typically captured during installation and the behavioral profile is periodically generated on the user's computer system (201) by using the web sites last visited by the user. The details captured are stored and regularly updated in the profile database (204).

The advertisement downloader and matcher module (ADM) (203) periodically runs on the user's computer system (201) and interacts with the personalization module (202) and the advertisement server (208). It is configured to download advertisements that match the rules specified by an advertiser on an advertisement server (208). It interacts with the personalization module (202) to obtain a user's demographic and behavioral details and uses these details to download corresponding matching advertisements. The downloaded advertisements are stored in an advertisement database (205).

The print spooler (206) is a standard component of the print system. It typically contains two parts: an operating system component to catch data destined for a printer and a program component that writes captured data to the printer. In an embodiment, the print spooler creates spool files using vector graphics format documents. In an embodiment, an Ad-Sponsored print driver is provided in the print sub-system of the user's computer system (201) which is configured to print advertisements with the vector graphics format document.

The print processor (207) is a component that converts the data to be printed to the form specific to a printer. It introduces a mechanism to insert advertisements into the vector graphics format documents independent to application data. In other words, the print processor inserts advertisements into the vector graphics format documents independent of the application type (for example, MS Word, MS Excel, MS Power Point, etc.) that generated the document for which a print request has been received by the user's computer system (201).

In an embodiment, the advertisement server (208) is web server implementation that hosts advertisements along with rules specified by an advertiser(s). The advertisers publish their advertisements to the web server for their later inclusion into the vector graphics format documents at the time of printing.

The printer (209) is a standard printer that may be an inkjet printer, a laser printer, an impact printer, a multipurpose printer or any other printer type.

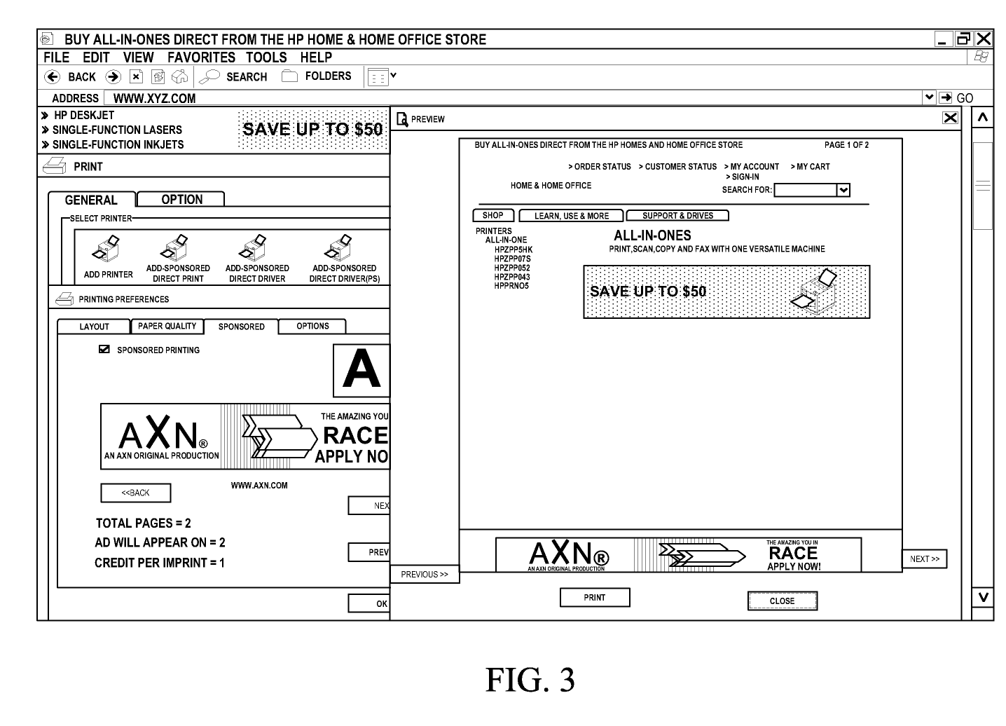

FIG. 3 shows an example of a computer user interface for printing an advertisement with a document according to an embodiment. It provides a view of the print and preview screens.

In an embodiment, the document is printed on a computer system having MS Windows XP as the operating system and MS Internet Explorer as the web browser. However, any other alternate operating system (such as, Linux) and browser (such as, Mozilla Firefox, Google Chrome etc.) may be used. The user interface provides for selection of an “Ad-Sponsored” print driver from the Printers and Faxes option of the Settings menu. As mentioned previously, the Ad-Sponsored print driver is a special purpose driver configured to record a vector graphics format document into a print driver queue. Once the special purpose print driver has been selected, the user interface provides a “Sponsored” tab on the Printing preferences properties of the selected printer driver. The Sponsored tab provides the option to select a “Sponsored Printing” check button and a “Preview” button. By selecting the Sponsored Printing check button, a user activates the sponsored printing process whereby a sponsored advertisement(s) gets printed with the document. The Preview button selection provides the user an option to preview the advertisement(s) that is/are getting printed along with the document.

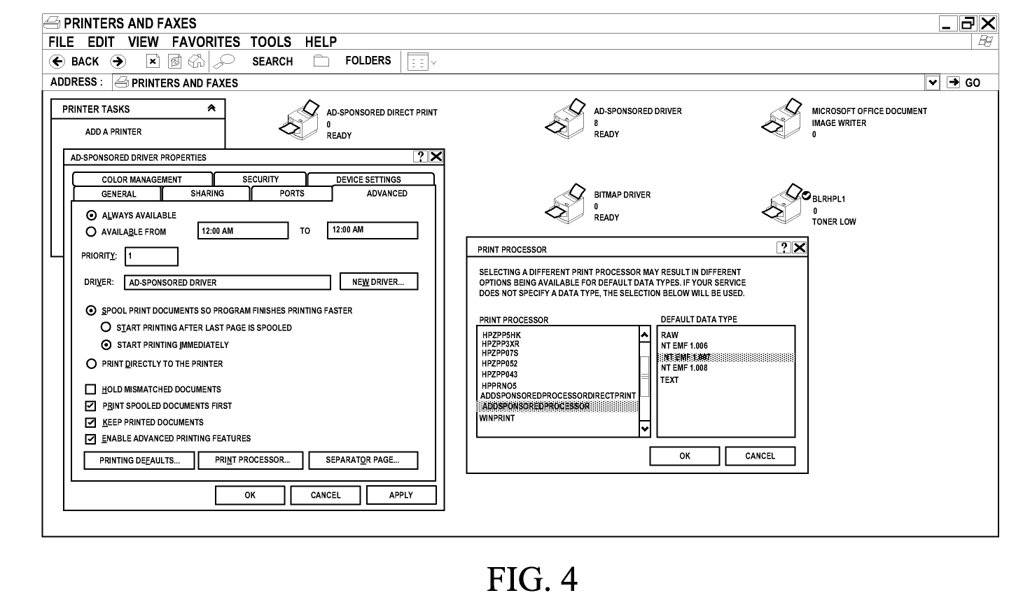

FIG. 4 shows an example of a computer user interface for the Ad-Sponsored driver queue configuration according to an embodiment. The user interface enables configuring the print processor of the print queue to use “Ad-Sponsored” print driver. In an embodiment, the default data type is selected to EMF data type.

Some of the advantages provided by the above described embodiments for printing an advertisement with a document may be summarized as follows:

The embodiment described provides an adaptive mechanism of printing an advertisement with a document that can be applied to any type of documents of a user. The embodiment described can be applied to any type of print system and provides a user with the ability to preview a document with an advertisement, independent to the document format.

It will be appreciated that the embodiments within the scope of the present invention may be implemented in the form of a computer program product including computer-executable instructions, such as program code, which may be run on any suitable computing environment in conjunction with a suitable operating system, such as, Microsoft Windows, Linux or UNIX operating system. Embodiments within the scope of the present invention may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present invention is for the purpose of illustration only. Although the invention has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present invention.

1. A method of printing an advertisement with a document, the method comprising:
receiving a print request for a document from a user;
converting the requested document into a vector graphics format document;
selecting at least one advertisement for inclusion into the vector graphics format document;
recording the vector graphics format document into a print driver queue enabled to print advertisements;
inserting the at least one advertisement into the vector graphics format document; and
printing the advertisement with the vector graphics format document.

2. A method according to claim 1, further comprising converting the requested document into an intermediate representation and inserting the at least one advertisement into the intermediate representation.

3. A method according to claim 1, further comprising displaying a print-preview of the document with the inserted advertisement.

4. A method according to claim 1, wherein the requested document is converted into a vector graphics format document independent of document generating application.

5. A method according to claim 1, wherein the at least one selected advertisement is a personalized advertisement.

6. A method according to claim 1, further comprising receiving one or more advertisements for inclusion based on a user's profile.

7. A method according to claim 1, wherein the vector graphics format is an enhanced media file format.

8. A method according to claim 1, wherein the at least one selected advertisement is received from a remote server.

9. A system for printing an advertisement with a document, the system comprising:
means for receiving a print request for a document from a user;
means for converting the requested document into a vector graphics format document;
means for selecting at least one advertisement for inclusion into the vector graphics format document;
means for recording the vector graphics format document into a print driver queue enabled to print advertisements;
means for inserting the at least one advertisement into the vector graphics format document; and
means for printing the advertisement with the vector graphics format document.

10. A system according to claim 9, further comprising means for displaying a print-preview of the document with the inserted advertisement.

11. A system according to claim 9, wherein the means convert the requested document into a vector graphics format document independent of document generating application.

12. A system according to claim 9, further comprising means for generating a personalized advertisement.

13. A system according to claim 9, further comprising means for receiving one or more advertisements for inclusion based on a user's profile.

14. A computer program comprising computer program means adapted to perform all of the steps of claim 1 when said program is run on a computer.

15. A computer program according to claim 14 embodied on a computer readable medium.
